(19) United States
(12) Patent Application Publication
(10) Pub. No.: US 2026/0296246 A1
(43) Pub. Date: Oct. 1, 2026

(54) MANAGEMENT APPARATUS AND MANAGEMENT METHOD

(71) Applicant: HONDA MOTOR CO., LTD., Tokyo (JP)

(72) Inventor: Hiroyuki KANAZAWA, Tokyo (JP)

(73) Assignee: HONDA MOTOR CO., LTD., Tokyo (JP)

(21) Appl. No.: 19/460,432

(22) Filed: Jan. 27, 2026

(30) Foreign Application Priority Data
Mar. 31, 2025 (JP) 2025-059001

(51) Int. Cl. B60L 53/62; B60L 53/66; G06Q 10/0631; H02J 7/82

(52) U.S. Cl. CPC B60L 53/62; B60L 53/66; G06Q 10/06315; H02J 7/82

(57) ABSTRACT

A management apparatus that manages a plurality of resources for responding to a demand response. The apparatus determines whether it is possible to meet a power condition of the demand response, based on information, at a first timing, determines whether it is possible to meet the power condition of the demand response at a second timing after the first timing and before an operation of DR, and determines whether it is possible to meet the power condition of the demand response while the demand response is in operation. The apparatus performs processing according to the result of each determination.

### CROSS-REFERENCE TO RELATED APPLICATION

This application claims priority to and the benefit of Japanese Patent Application No. 2025-059001 filed on March 31, 2025, the entire disclosure of which is incorporated herein by reference.

### BACKGROUND OF THE INVENTION

### FIELD OF THE INVENTION

The present invention relates to a management technique of resources for use in demand response.

### DESCRIPTION OF THE RELATED ART

In recent years, research and development on resource utilization that contribute to energy efficiency are conducted in order to ensure that more people are able to access affordable, reliable, sustainable, and advanced energy. Japanese Patent Application Laid-Open No. 2022-173750 proposes a technique for managing resources utilized for demand response (DR), and discloses a system that utilizes a storage battery provided in a base station. In the system of Japanese Patent Application Laid-Open No. 2022-173750, after the storage battery (the base station) is selected in accordance with DR, when the fact that it is impossible to meet DR is detected, control is selectively conducted on whether to compensate using another base station or compensate in the selected base station.

Resources of mobilities on which secondary batteries are mounted tend to vary in use opportunity, and resources scheduled to be utilized for DR cannot be utilized, in some cases. There is a need for managing resources with more certainty from a DR contract to a DR operation.

### SUMMARY OF THE INVENTION

It is an object of the present invention to provide a technique for responding to DR by utilizing resources with more certainty from a DR contract to a DR operation.

According to an aspect of the present invention, there is provided a management apparatus that manages a plurality of resources for responding to a demand response, the management apparatus comprising: an acquisition unit configured to acquire information with respect to situations of the plurality of resources; a first determination unit configured to determine whether it is possible to meet a power condition of the demand response, based on the information, at a first timing after a contract of the demand response and before an operation of the demand response; a second determination unit configured to determine whether it is possible to meet the power condition of the demand response, based on the information, at a second timing after the first timing and before the operation; a third determination unit configured to determine whether it is possible to meet the power condition of the demand response, based on the information, while the demand response is in operation, a first processing unit configured to execute processing of supplementing an external resource different from the plurality of resources, in a case where the first determination unit determines that it is impossible to meet the power condition of the demand response; a second processing unit configured to reallocate resources scheduled to be operated among the plurality of resources, in a case where the second determination unit determines that it is impossible to meet the power condition of the demand response; and a third processing unit configured to change power operation amounts of resources in operation, in a case where the third determination unit determines that it is impossible to meet the power condition of the demand response.

Further features of the present invention will become apparent from the following description of exemplary embodiments (with reference to the attached drawings).

### BRIEF DESCRIPTION OF THE DRAWINGS

FIG. 1 is a schematic diagram of a management system using a management apparatus according to one embodiment of the present invention;

FIG. 2 is an explanatory diagram of a power transmission system in the management system of FIG. 1;

FIG. 3 is a diagram illustrating a configuration example of information registered in a database;

FIG. 4 is a block diagram of an in-vehicle terminal;

FIG. 5 is a block diagram of a mobile terminal;

FIGS. 6A and 6B are flowcharts illustrating an example of processing for updating the database;

FIG. 7 is a diagram illustrating an outline of processing contents from a DR contract to a DR operation;

FIG. 8 is a flowchart illustrating an example of processing executed by the management apparatus;

FIG. 9 is a flowchart illustrating an example of processing executed by the management apparatus; and

FIGS. 10A to 10D are each a flowchart of an example of processing executed by the management apparatus.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments. Two or more of the multiple features described in the embodiments may be combined as appropriate. Furthermore, the same reference numerals are given to the same or similar configurations, and redundant description thereof is omitted.

### Outline of System

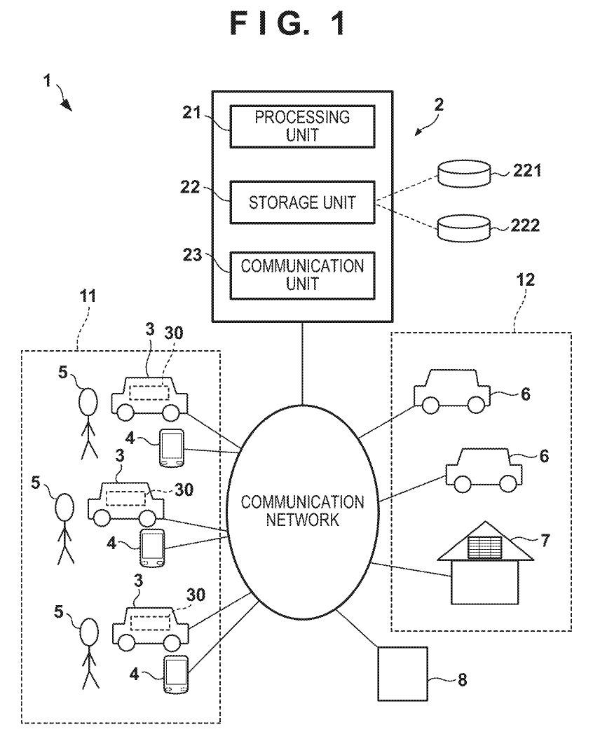

FIG. 1 is a schematic diagram of a management system 1, which uses a management apparatus 2, according to one embodiment of the present invention. In the management system 1, the management apparatus 2 manages resources 3, each of which is a distributed energy resource. These resources are utilized for DR for maintaining a supply-demand balance of electric power. The management apparatus 2 denotes a server that functions as an aggregator for utilizing the resource 3 through a communication network such as the Internet.

In the present embodiment, each resource 3, which responds to DR, is a battery-mounted vehicle represented by an electric vehicle, a hybrid vehicle, or an electric motorcycle, and includes an in-vehicle terminal 30. A user 5 of the resource 3 is a registered user who permits the provider of the management apparatus 2 to operate the resource 3 for DR beforehand, and the resources 3 are registered resources. A registered resource group 11 is a group including a plurality of resources 3 that permit the operation of electric power beforehand in this manner. The management apparatus 2 is capable of wirelessly communicating with the in-vehicle terminal 30 of the resource 3 and a mobile terminal 4 through a communication network.

The management apparatus 2 participates in DR by basically utilizing the resources 3 included in the registered resource group 11. However, in a predetermined case, resources 6 and 7, which belong to an external resource group 12, can also be utilized. The external resource group 12 includes resources that do not permit the provider of the management apparatus 2 to operate beforehand. As an example, the resource 6 is a battery-mounted vehicle represented by a hybrid vehicle or an electric motorcycle, and the resource 7 is a residence equipped with a solar panel. When utilizing such an external resource group 12, the management apparatus 2 individually obtains permission, or requests another aggregator to supply or demand the electric power via a server 8, which is operated by that aggregator, to respond to DR.

The management apparatus 2 is a server computer including a processing unit 21, a storage unit 22, and a communication unit 23. The processing unit 21 is a processor represented by a CPU, and executes a program stored in the storage unit 22. The storage unit 22 is a storage device such as a RAM, a ROM or a hard disk, which stores programs to be executed by the processing unit 21 and various types of data. In the storage unit 22, a resource database 221 in which information with respect to registered resources is accumulated, and a DR database 222 in which information with respect to DR is accumulated, are constructed. The communication unit 23 includes a communication interface that communicates with an external communication terminal through a communication network.

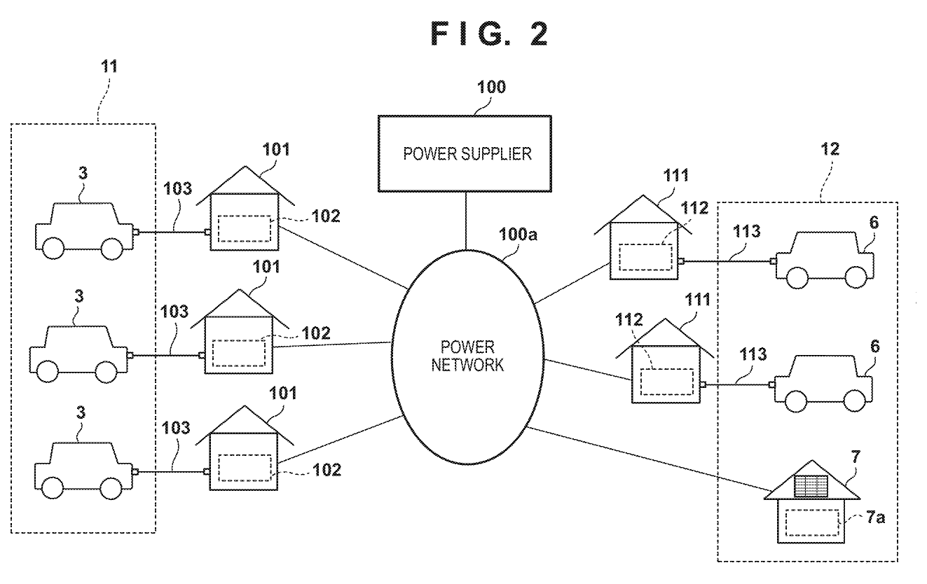

FIG. 2 is an explanatory diagram of a power transmission system in the management system 1. A power supplier 100 is, for example, a grid electric power company including a large-scale power plant, and can sell the electric power to consumers or purchase surplus electric power. The power supplier 100, which is illustrated, is also used as a concept indicating facilities such as a power distribution facility, a power transmission facility, and a transformation facility that constitute a power system together with a power network 100a.

Each resource 3, which belongs to the registered resource group 11, is connected to the power network 100a via a power facility 102 of a residence 101 of the user 5, as an example. The resource 3 is connected to the power facility 102 through a power cable (a charging cable) 103, which is detachable from the resource 3. The power facility 102 includes, for example, a distribution board, a relay, and a controller, and relays charging and discharging between the resource 3 in connection with the power cable 103 and the power network 100a. When the resource 3 is connected to the power cable 103, the in-vehicle terminal 30 becomes capable of conducting control for charging the battery included in the resource 3 with the electric power supplied from the power network 100a or discharging the battery to the power network 100a. Therefore, when the management apparatus 2 instructs the in-vehicle terminal 30 on communication to charge or discharge, it becomes possible to utilize the resource 3 for DR through the power network 100a.

Each resource 6, which belongs to the external resource group 12, is also connected to the power network 100a via a power facility 112 of a residence 111 of its user, as an example. The resource 6 is connected to the power facility 112 through a cable 113, which is detachable from the resource 6. The resource 7 is also connected to the power network 100a via a power facility 7a in its residence.

### Database

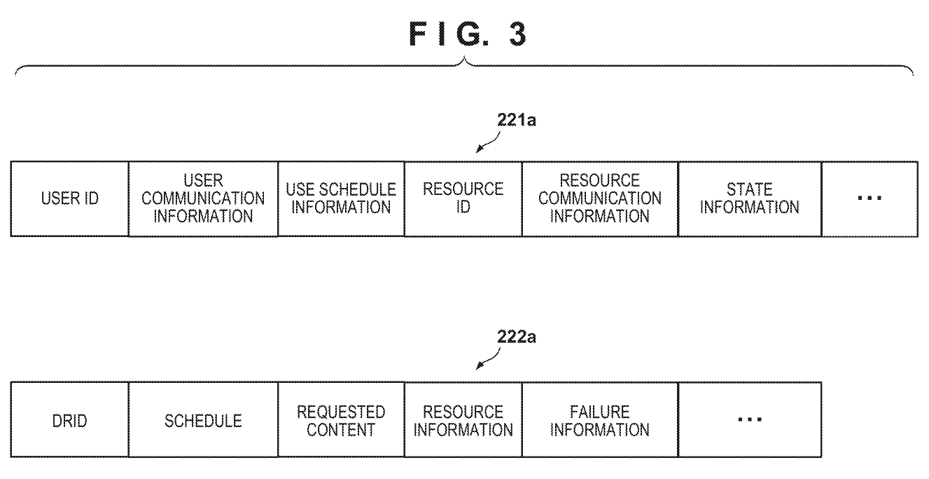

An example of information accumulated in the resource database 221 and the DR database 222 of the management apparatus 2 will be described. FIG. 3 illustrates a configuration example of a record 221a, which is accumulated in the resource database 221, and a configuration example of a record 222a, which is accumulated in the DR database 222.

The record 221a is created for every user 5, and includes “user ID”, “user communication information”, “use schedule information”, “resource ID”, “resource communication information”, and “state information”. The “user ID”

denotes an identifier for identifying the user 5. The “user communication information” denotes information necessary for the mobile terminal 4 of the user 5 and the management apparatus 2 to communicate with each other through the communication network, and is, for example, an identification number on communication of the mobile terminal 4. The “use schedule information” denotes date and time information of a period while the user 5 uses the resource 3 (date and time information of a period while the resource 3 cannot be utilized for DR) or date and time information of a period while the resource 3 is allowed to be utilized for DR.

The “resource ID” denotes an identifier for identifying the resource 3. The “resource communication information” denotes information necessary for communication between the resource 3 of the user 5, which is identified by the “user ID”, and the management apparatus 2 through the communication network, and is, for example, an identification number on communication of the in-vehicle terminal 30. The “state information” denotes information with respect to the state of charge and a utilization preparation state of the resource 3, and is, for example, information such as a state of charge (SOC) of the resource 3 or a connection state of the power cable 103 to the resource 3 (which cannot be utilized unless connected).

The record 222a is created for every DR that has been contracted, and includes “DRID”, “schedule”, “requested content”, “resource information”, and “failure information”. “DRID” denotes an identifier for identifying DR. The “schedule” denotes date and time information with respect to a DR operation period. The “requested content” denotes information with respect to electric power requested in DR, and includes information with respect to whether the electric power is demanded or supplied and an upper limit amount of the electric power. The “resource information” denotes information for identifying a resource group that is scheduled to be utilized for DR or that is actually being utilized. The “failure information” denotes information with respect to a failure that has occurred during DR operation.

### Configuration of Terminal

FIG. 4 is a block diagram of a configuration of the in-vehicle terminal 30 and its periphery. The in-vehicle terminal 30 in the present embodiment is an ECU that controls charging and discharging of a battery 35 mounted on the resource 3. The in-vehicle terminal 30 is a computer including a processing unit 31, a storage unit 32, an input and output interface (I/F) unit 33, and a communication unit 34. The processing unit 31 is a processor represented by a CPU, and executes a program stored in the storage unit 32. The storage unit 32 is a storage device such as a RAM, a ROM or a hard disk, which stores programs to be executed by the processing unit 31 and various types of data. The input and output I/F unit 33 relays a signal between a peripheral device of the in-vehicle terminal 30 and the processing unit 31. The communication unit 34 includes a communication interface that communicates with the management apparatus 2 through a communication network and a communication interface that communicates with the mobile terminal 4.

The battery 35 is, for example, a secondary battery such as a lithium ion battery, and is, for example, a battery that supplies the electric power to a traveling drive source (for example, a motor) of the resource 3. A charge and discharge circuit 36 includes an AC/DC converter, a DC/AC converter, and a control circuit that controls electric current and voltage, converts AC power supplied from the power facility 102 (the power network 100a) of the residence 101 into DC power to charge the battery 35 through the power cable 103 in connection with a connector 37, or converts DC power stored in the battery 35 into AC power to discharge the AC power to the power facility 102 (the power network 100a). A

sensor 38 is a sensor that measures a direct current and a voltage between the charge and discharge circuit 36 and the battery 35, and is capable of estimating a charge amount or a discharge amount from a detection result. That is, the in-vehicle terminal 30 is capable of estimating the SOC of the battery 35 from the detection result of the sensor 38. The estimated SOC can be stored in the storage unit 32.

The connector 37 includes a connection terminal for an electric power line connected to the charge and discharge circuit 36, and a connection terminal for a communication line connected to the in-vehicle terminal 30, and the power cable 103 includes the power line and the communication line. The in-vehicle terminal 30 is capable of communicating with the power facility 102 through the communication line. When the communication is established, the in-vehicle terminal 30 is capable of determining that the power cable 103 is in connection with the resource 3. The determination result can be stored in the storage unit 32.

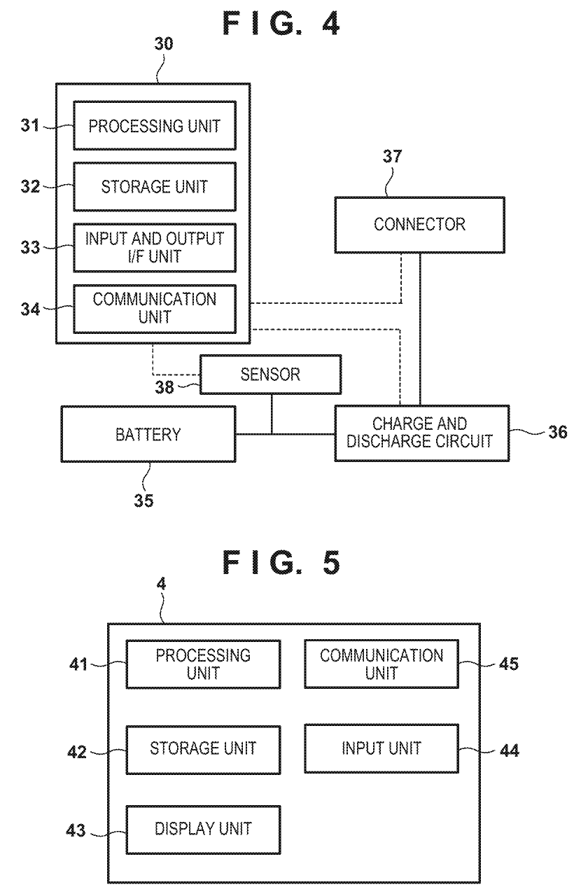

FIG. 5 is a block diagram of the mobile terminal 4. The mobile terminal 4 is a communication terminal including a processing unit 41, a storage unit 42, a display unit 43, an input unit 44, and a communication unit 45, and is, for example, a smartphone. The processing unit 41 is a processor represented by a CPU, and executes a program stored in the storage unit 42.

The storage unit 42 is a storage device such as a RAM and a ROM. In the storage unit 42, an application program (referred to as a DR application) useful for the user 5 to participate in the management system 1 is stored. The display unit 43 is, for example, a device that displays an image and that also accepts an input operation by the user 5, such as a touch panel. The input unit 44 is a device that receives a touch operation by the user. The communication unit 45 includes: a communication interface that communicates with the management apparatus 2 through a communication network; and a communication interface that communicates with the in-vehicle terminal 30.

### Update of Database

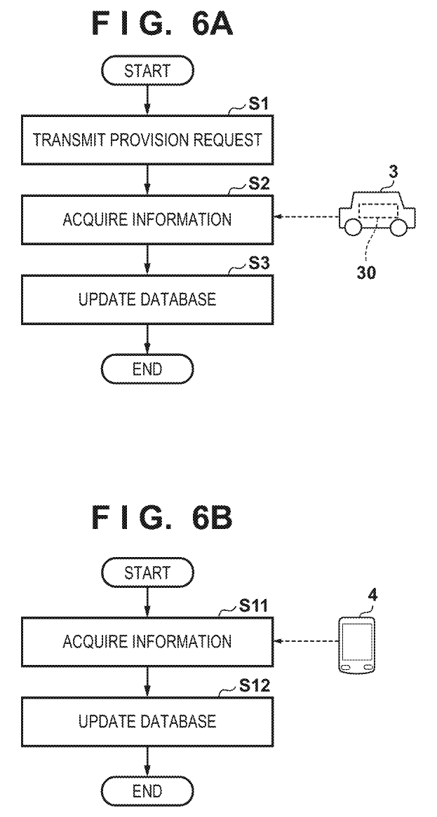

By updating the resource database 221, it is possible to maintain the accumulated information as the latest information. FIG. 6A illustrates an example of processing periodically performed by the processing unit 21 of the management apparatus 2, and illustrates, in particular, an example of acquiring the vehicle state information from the resource 3 and updating the resource database 221. The vehicle state information denotes information accumulated in the “state information” of the record 221a in FIG. 3.

In step S1, a provision request for information is transmitted to the in-vehicle terminal 30. The in-vehicle terminal 30 that has received the provision request transmits, to the management apparatus 2, various types of information stored in the storage unit 32 together with a resource ID. In step S2, the information received from the in-vehicle terminal 30 is acquired as the vehicle state information, and in step S3, the “state information” of the corresponding resource 3 is updated. In this manner, the “state information” is maintained as the latest information.

FIG. 6B illustrates an example of processing performed by the processing unit 21 of the management apparatus 2 in relation to updating the “use schedule information” of the record 221a of FIG. 3. In the present embodiment, the update of the “use schedule information” is triggered by an update notification from the user 5. The user 5 starts the DR application on the mobile terminal 4 to establish communication with the management apparatus 2. Then, the user 5 performs an operation of transmitting, to the management apparatus 2, either a use schedule or a DR participation permission period of the resource 3 that has been input on the DR application. The information that has been input by the user 5 is transmitted to the management apparatus 2 together with the user ID.

In step S11, the information that has been received from the mobile terminal 4 is acquired as the use schedule information, and in step S12, the “use schedule information” of the corresponding user 5 is updated. In this manner, the “use schedule information” is maintained as the latest information.

Note that in the present embodiment, the use schedule information is transmitted to the management apparatus 2 from the mobile terminal 4. However, the use schedule information may be transmitted to the in-vehicle terminal 30 from the mobile terminal 4 on wireless communication and then stored, and may be transmitted to the management apparatus 2 from the in-vehicle terminal 30 in the processing of FIG. 6A. In this case, the processing of FIG. 6B is unnecessary.

### Resource Management for DR

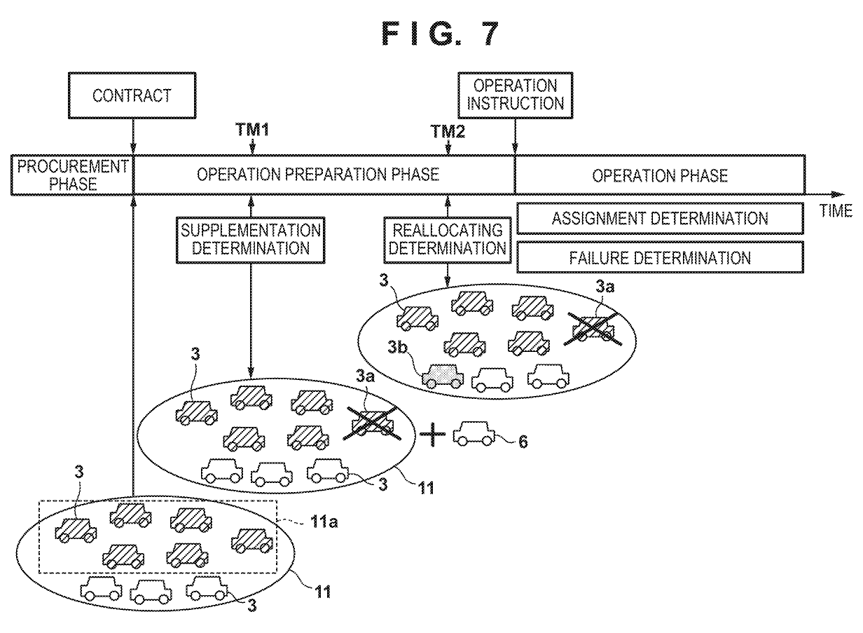

An example of a management procedure of the resources 3 for DR to be performed by the management apparatus 2 will be described with reference to FIG. 7. FIG. 7 is a diagram illustrating an outline of processing contents of the management apparatus 2 from a DR contract to a DR operation. In the example of FIG. 7, a series of conducts for DR is divided into a procurement phase, an operation preparation phase, and an operation phase in a time-series and virtual manner. The procurement phase denotes a bidding phase for a DR item. A successful bid is made, and a contract is agreed, and then the operation preparation phase starts. There is an operation command for the contracted DR, and then the operation phase starts.

When the DR item is contracted, the resources 3 to be utilized at the time of operation and a power operation amount (a supply-demand amount) of each resource 3 are provisionally determined. When the contract is agreed, resources 3 scheduled to be operated are selected from the resources 3 included in the registered resource group 11, and the selected content is accumulated as the “resource information” in the DR database. In this selection, a suppliable resource amount is predicted, based on, for example, the “use schedule information” and the “state information” of the resource database 221 with reference to whether it is possible to meet the requested content for the DR item. In FIG. 7, when the contract is agreed, the resources 3, which are scheduled to be operated from the registered resource group 11, are illustrated as a temporarily selected resource group 11a.

The SOC and the use situation of the resource 3 fluctuate. In the operation preparation phase, whether the resource group 11a is capable of responding to the contracted DR item is determined a plurality of times to take measures.

First, a supplementation determination is made at timing TM1. The timing TM1 denotes, for example, a timing on a day before the scheduled operation date and time. More specifically, the timing TM1 is, for example, a timing in a period of time from the contract to six hours before the scheduled operation date and time for DR.

In the supplementation determination, it is determined whether the temporarily selected resource group 11a is capable of responding to power conditions (a supply-demand power amount and a supply-demand period) of DR. In this determination, the resource amount suppliable by the temporarily selected resource group 11a is predicted, based on, for example, the “use schedule information” and the “state information” in the resource database 221 with reference to whether it is possible to meet the power conditions of DR. In a case where the suppliable resource amount that has been predicted is smaller than the temporarily contracted resource amount, it is determined that it is impossible to meet the power conditions of DR. In a case where it is determined that it is impossible to meet them, a resource that belongs to the external resource group 12 is utilized from the viewpoint that there is a relatively long time until the scheduled operation date and time of DR and operation of the contracted DR is to be ensured. In the example of FIG. 7, it has been found that it is impossible to utilize a resource 3a that is scheduled to be utilized. Thus, instead of this, an example of utilizing the resource 6 is assumed. The external resource group 12 is utilized by requesting the server 8 to use electric power managed by the aggregator of the server 8 or requesting individual resources.

Next, a reallocating determination is executed at timing TM2. The timing TM2 is, for example, a timing on the day of the scheduled operation date and time. More specifically, the timing TM2 is, for example, a timing in a period of time from six hours before the scheduled operation date and time to the scheduled operation date and time.

In the reallocating determination, it is determined whether the temporarily selected resource group 11a (the resource group after the supplementation in a case where the supplementation is performed in the supplementation determination) is capable of responding to the power conditions of DR. In this determination, the resource amount suppliable by the temporarily selected resource group 11a is predicted, based on, for example, the “use schedule information” and the “state information” in the resource database 221 with reference to whether it is possible to meet the power conditions of DR. In a case where an actually ensured resource amount is smaller than the temporarily contracted resource amount, it is determined that it is impossible to meet the power conditions of DR. In a case where it is determined that it is impossible to meet them, another resource 3 that belongs to the registered resource group 11 is reallocated, because the scheduled operation date and time of DR is coming. In the example of FIG. 7, it has been found that it is impossible to utilize the resource 3a that is scheduled to be utilized. Thus, instead of this, an example of utilizing a resource 3b is assumed. The resource 3b is selected, based on the “use schedule information” and the “state information” in the resource database 221.

In the operation phase, an assignment determination and a failure determination are executed. In the assignment determination, it is determined whether it is possible for the resource group while in operation to meet the power conditions. In this determination, the resource amount suppliable by the resource group while in operation is predicted, based on, for example, the “use schedule information” and the “state information” in the resource database 221 with reference to whether it is possible to continuously meet the power conditions of DR. In a case where it is determined that it is impossible to meet them, the power operation amount (the supply-demand amount) of each resource in the resource group while in operation is changed to meet them. The same procedure also applies to a case of using a resource other than the registered resource group 11.

In the failure determination, it is determined whether an inoperable situation (a failure) is occurring in an individual resource while in operation. This determination is made in accordance with, for example, a result of communication with the individual resource 3. As an example, in a case where communication with the in-vehicle terminal 30 of the resource 3 is disabled, in a case where the in-vehicle terminal 30 of the resource 3 gives a notification that the connection between the power cable 103 and the resource 3 is released, in a case where the in-vehicle terminal 30 of the resource 3 gives a notification that it is impossible to confirm the charge or discharge amount of the battery 35 based on a detection result of the sensor 38, in a case where the in-vehicle terminal 30 of the resource 3 gives a notification that the charge or discharge amount of the battery 35 based on the detection result of the sensor 38 does not reach an instructed content of the management apparatus 2, or the like, such a resource is inoperable, and a failure is determined. The same reasoning also applies to a case of using a resource other than the registered resource group 11. Processing of a case where the failure is determined will be described later.

### Processing Example

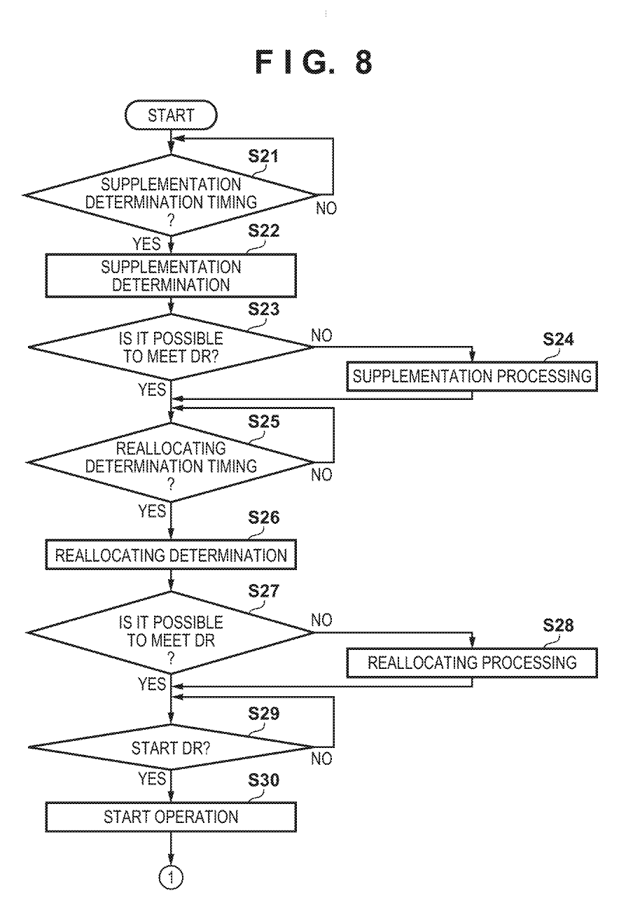

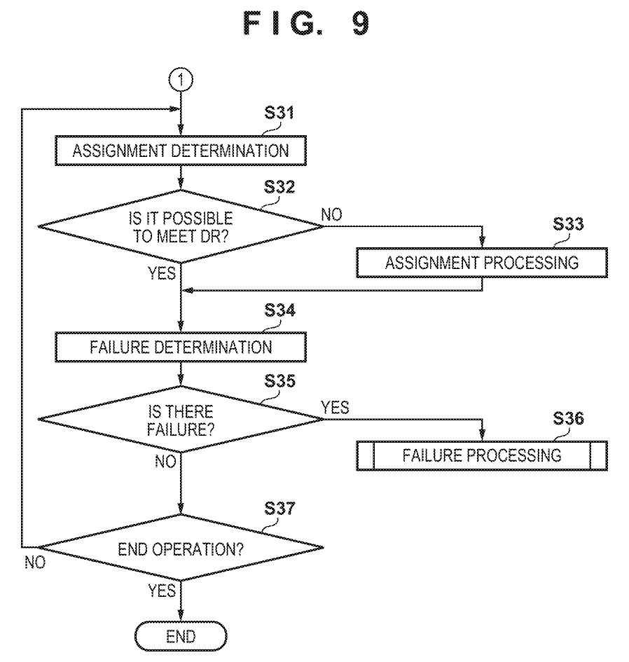

FIGS. 8 and 9 are flowcharts illustrating an example of processing executed by the processing unit 21 of the management apparatus 2, and in particular, are flowcharts illustrating an example of processing after the contract in the example of FIG. 7.

In step S21, it is determined whether it is timing TM1 for the supplementation determination, based on the current date and time and information of the “schedule” in the DR database 222. In a case where it is the timing TM1, the processing proceeds to step S22.

In step S22, a supplementation determination is executed. Here, as described with reference to FIG. 7, it is determined whether the temporarily selected resource group 11a is capable of responding to the power conditions of DR. In step S23, it is determined whether it is possible to meet DR in accordance with a determination result in step S22. In a case where it is possible to meet DR, the processing proceeds to step S25. In a case where it is impossible to meet DR, the processing proceeds to step S24.

In step S24, supplementation processing is executed. Here, as described with reference to FIG. 7, processing such as requesting the server 8 on communication to use the electric power managed by the aggregator of the server 8 is performed, and resources other than the registered resource group 11 are ensured. Then, the processing proceeds to step S25.

In step S25, it is determined whether it is timing TM2 for the reallocating determination, based on the current date and time and the information of the “schedule” in the DR database 222. In a case where it is the timing TM2, the processing proceeds to step S26.

In step S26, a reallocating determination is executed. Here, as described with reference to FIG. 7, it is determined whether the temporarily selected resource group 11a (a resource group after supplementation, in the case where the supplementation is determined in the supplementation determination) is capable of responding to the power conditions of DR.

In step S27, it is determined whether it is possible to meet DR in accordance with a determination result in step S26. In a case where it is possible to meet DR, the processing proceeds to step S29. In a case where it is impossible to meet DR, the processing proceeds to step S28.

In step S28, reallocating processing is executed. Here, as described with reference to FIG. 7, the resource 3 to be operated is changed, and another resource 3, which belongs to the registered resource group 11, is selected as the resource scheduled to be operated.

In step S29, it is determined whether the DR operation starts. For example, in a case where the scheduled start date and time has come, or in a case where, for example, an operation instruction has been given from the server of a DR request source to the management apparatus 2 through a communication network, it is determined that the operation of DR starts.

In step S30, the operation of a finally selected resource group starts to respond to DR. For example, the management apparatus 2 gives an instruction of the supply-demand power amount of the battery 35 and its operation to the in-vehicle terminal 30. During operation, when the server of the DR request source gives an instruction of the supply-demand power amount to the management apparatus 2 through a communication network, such an instruction is followed in real time.

In step S31, an assignment determination is executed. Here, as described with reference to FIG. 7, it is determined whether the resource group while in operation is capable of responding to the power conditions. In step S32, it is determined whether it is possible to meet DR in accordance with a determination result in step S31. In a case where it is possible to meet DR, the processing proceeds to step S34. In a case where it is impossible to meet DR, the processing proceeds to step S33.

In step S33, assignment processing is executed. Here, as described with reference to FIG. 7, the power operation amount (the supply-demand power amount) of each resource in the resource group while in operation is changed. Then, for example, the management apparatus 2 gives an instruction of the power operation amount after the change of the battery 35 and its operation to the in-vehicle terminal 30 of the resource 3 while in operation. Then, the processing proceeds to step S34.

In step S34, a failure determination is executed. Here, as described with reference to FIG. 7, it is determined whether a failure is occurring in each resource while in operation. In step S35, it is determined whether a determination result of step S34 is a failure. In a case where there is no failure in any of the resources, the processing proceeds to step S37. In a case where there is a failure in any one of the resources, the processing proceeds to step S36.

In step S37, it is determined whether the operation of DR ends. For example, in a case where the scheduled end date and time has come, or in a case where, for example, an end instruction has been given from the server of the DR request source to the management apparatus 2 through a communication network, it is determined that the operation of DR ends. In a case where it is determined that the operation of DR ends, the processing ends. In a case where it is determined that the operation of DR does not end, the processing returns to step S31, and repeats the same processing.

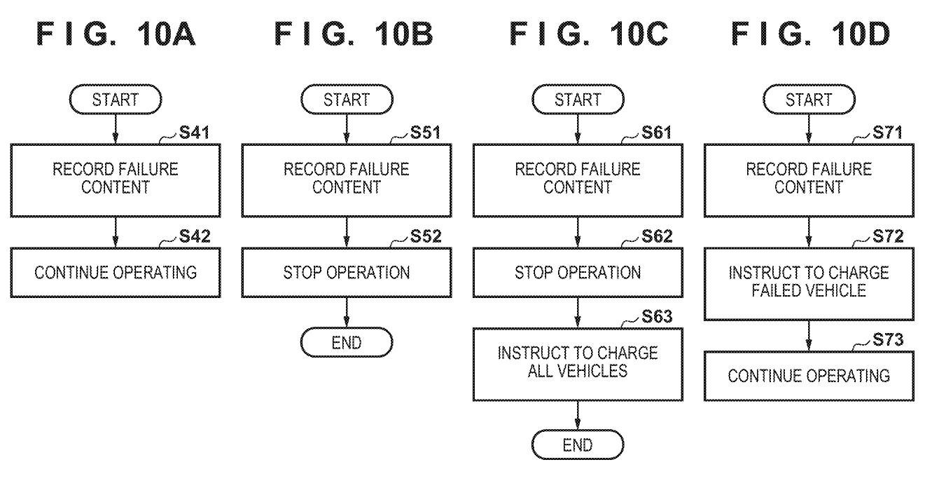

In step S36, failure processing is performed. FIG. 10A is a flowchart illustrating failure processing A as an example.

In step S41, the resource that has been determined as a failure is identified, and its failure content is recorded. The failure content is stored in, for example, “failure information” in the DR database 222. Verification for a failure cause after the failure is enabled, and is usable for the DR operation in the future.

In step S42, the operation of DR continues, and the operation continues using a resource without a failure. The processing proceeds to step S37. As a result, depending on the case, it may not be possible to conduct DR partially later, but this is inevitable.

Another processing example of the failure processing in step S36 will be described. FIG. 10B is a flowchart illustrating failure processing B as another processing example of the failure processing in step S36.

In step S51, the failure content is recorded. This is the same processing as step S41. In step S52, the operation of DR stops, and the operation of all resources stops. For example, the management apparatus 2 instructs the in-vehicle terminal 30 of the resource 3 while in operation to stop charging and discharging the battery 35. This prevents an occurrence of the failure in the entirety of the management system 1 due to the failure of one resource.

FIG. 10C is a flowchart illustrating failure processing C as still another processing example of the failure processing in step S36.

In step S61, the failure content is recorded. This is the same processing as step S41. In step S62, the operation of DR stops, and the operation of all resources stops. Performing of subsequent operation of DR is given up. This is the same processing as step S52. In step S63, an instruction to start charging the battery 35 by a predetermined amount is given to the in-vehicle terminals 30 of all the resources 3 that have been in operation. This avoids a situation in which the resource 3, which is a vehicle, is not capable of moving due to shortage of electric power, so that the convenience of the user 5 can be ensured.

FIG. 10D is a flowchart illustrating failure processing D as still another processing example of the failure processing in step S36.

In step S71, the failure content is recorded. This is the same processing as step S41. In step S72, an instruction to start charging the battery 35 by a predetermined amount is given only to the in-vehicle terminal 30 including the resource 3 that has been determined to have failed. This avoids a situation in which the resource 3 that has been determined to have failed is not capable of moving due to shortage of electric power. The convenience of the user 5 can be ensured. In step S73, the operation of DR continues, and the operation continues using a resource without a failure. The processing proceeds to step S37. As a result, depending on the case, it may not be possible to conduct DR partially later, but this is inevitable.

Note that any one of the failure processing A to D may be selectively performed as the failure processing in step S36 in accordance with a situation. The selectable failure processing may include four types of failure processing A to D or three types of failure processing A to D. In the case of the three types, the selectable failure processing may be the failure processing A to C. A selection condition may be, for example, the number of failed resources or the failure content. Priority may be given in selection, and for example, the priority of the failure processing A may be lowest, and the failure processing A < the failure processing B < the failure processing C or the failure processing D may be satisfied.

As described heretofore, in the present embodiment, measures are taken by checking whether it is possible to meet DR in each phase in a stepwise manner from the DR contract to the DR operation, so that it becomes possible to respond to DR by utilizing resources with more certainty from the DR contract to the DR operation.

### Summary of Embodiments

The above embodiments disclose at least a management apparatus and a management method in the following items.

### Item 1.

A management apparatus that manages a plurality of resources for responding to a demand response, the management apparatus comprising:

an acquisition unit configured to acquire information with respect to situations of the plurality of resources;

a first determination unit configured to determine whether it is possible to meet a power condition of the demand response, based on the information, at a first timing after a contract of the demand response and before an operation of the demand response;

a second determination unit configured to determine whether it is possible to meet the power condition of the demand response, based on the information, at a second timing after the first timing and before the operation;

a third determination unit configured to determine whether it is possible to meet the power condition of the demand response, based on the information, while the demand response is in operation,

a first processing unit configured to execute processing of supplementing an external resource different from the plurality of resources, in a case where the first determination unit determines that it is impossible to meet the power condition of the demand response;

a second processing unit configured to reallocate resources scheduled to be operated among the plurality of resources, in a case where the second determination unit determines that it is impossible to meet the power condition of the demand response; and

a third processing unit configured to change power operation amounts of resources in operation, in a case where the third determination unit determines that it is impossible to meet the power condition of the demand response.

According to this embodiment, it becomes possible to respond to DR by utilizing the resources with more certainty from the DR contract to the DR operation.

### Item 2.

The management apparatus according to Item 1, wherein

each of the plurality of resources is a vehicle including a battery, and

the management apparatus further comprises a fourth determination unit configured to determine, while in operation of the demand response, whether there is an inoperable resource for the demand response among the resources in operation.

According to this embodiment, it becomes possible to determine an operational failure and take measures.

### Item 3.

The management apparatus according to Item 2, wherein

in a case where the fourth determination unit determines that there is the inoperable resource for the demand response among the resources in operation, information for identifying the inoperable resource is recorded, and the operation for the demand response continues.

According to this embodiment, when an operational failure occurs, it becomes possible to respond to DR while enabling verification after the failure.

### Item 4.

The management apparatus according to Item 2, further comprising

a fourth processing unit configured to execute processing to stop the operation for the demand response, in a case where the fourth determination unit determines that there is the inoperable resource among the resources in operation.

According to this embodiment, in a case where an operational failure occurs, it becomes possible to avoid a further failure of the system while enabling verification after the failure.

### Item 5.

The management apparatus according to Item 2, further comprising

a fourth processing unit configured to cause all resources in operation to start charging by a predetermined amount, in a case where the fourth determination unit determines that there is the inoperable resource among the resources in operation.

According to this embodiment, when an operational failure occurs, it becomes possible to ensure the movement of the vehicle, which is a resource, so that the convenience of the user can be ensured.

### Item 6.

The management apparatus according to Item 2, further comprising

a fourth processing unit configured to identify the inoperable resource and start charging only the identified resource by a predetermined amount, in a case where the fourth determination unit determines that there is the inoperable resource among the resources in operation.

According to this embodiment, when an operational failure occurs, it becomes possible to ensure the movement of a failed vehicle, which is a resource, so that the convenience of the user can be ensured.

### Item 7.

The management apparatus according to Item 1, wherein

each of the plurality of resources is a vehicle including a battery, and

the information includes:

vehicle state information including a state of charge (SOC) of the battery and a connection state between the vehicle and a power cable; and

schedule information indicating a use schedule of the vehicle.

According to this embodiment, the determination at each stage can be made with more accuracy.

### Item 8.

The management apparatus according to Item 7, further comprising

a communication unit capable of performing wireless communication with the vehicle, wherein

at least a part of the information is acquired from the vehicle through the communication unit.

According to this embodiment, the latest information is easily obtained.

### Item 9.

The management apparatus according to Item 7, further comprising

a communication unit capable of performing wireless communication with a communication terminal of a user of the vehicle, wherein

at least a part of the information is acquired from the communication terminal through the communication unit.

According to this embodiment, the latest information is easily obtained.

### Item 10.

A management method for managing a plurality of resources for responding to a demand response, the management method comprising:

an acquisition step of acquiring information with respect to situations of the plurality of resources;

a first determination step of determining whether it is possible to meet a power condition of the demand response, based on the information, at a first timing after a contract of the demand response and before an operation of the demand response;

a second determination step of determining whether it is possible to meet the power condition of the demand response, based on the information, at a second timing after the first timing and before the operation;

a third determination step of determining whether it is possible to meet the power condition of the demand response, based on the information, while the demand response is in operation,

a first processing step of performing processing of supplementing an external resource different from the plurality of resources, in a case where the first determination step determines that it is impossible to meet the power condition of the demand response;

a second processing step of reallocating a resource scheduled to be operated among the plurality of resources, in a case where the second determination step determines that it is impossible to meet the power condition of the demand response; and

a third processing step of changing a power operation amount of the plurality of resources in operation, in a case where the third determination step determines that it is impossible to meet the power condition of the demand response.

According to this embodiment, it becomes possible to respond to DR by utilizing the resources with more certainty from the DR contract to the DR operation.

While an embodiment has been described, the invention is not limited to the foregoing embodiments, and various variations/changes are possible within the spirit of the invention.

What is claimed is:

1. A management apparatus that manages a plurality of resources for responding to a demand response, the management apparatus comprising:
an acquisition unit configured to acquire information with respect to situations of the plurality of resources;
a first determination unit configured to determine whether it is possible to meet a power condition of the demand response, based on the information, at a first timing after a contract of the demand response and before an operation of the demand response;
a second determination unit configured to determine whether it is possible to meet the power condition of the demand response, based on the information, at a second timing after the first timing and before the operation;
a third determination unit configured to determine whether it is possible to meet the power condition of the demand response, based on the information, while the demand response is in operation,
a first processing unit configured to execute processing of supplementing an external resource different from the plurality of resources, in a case where the first determination unit determines that it is impossible to meet the power condition of the demand response;
a second processing unit configured to reallocate resources scheduled to be operated among the plurality of resources, in a case where the second determination unit determines that it is impossible to meet the power condition of the demand response; and
a third processing unit configured to change power operation amounts of resources in operation, in a case where the third determination unit determines that it is impossible to meet the power condition of the demand response.

2. The management apparatus according to claim 1, wherein
each of the plurality of resources is a vehicle including a battery, and
the management apparatus further comprises a fourth determination unit configured to determine, while in operation of the demand response, whether there is an inoperable resource for the demand response among the resources in operation.

3. The management apparatus according to claim 2, wherein
in a case where the fourth determination unit determines that there is the inoperable resource for the demand response among the resources in operation, information for identifying the inoperable resource is recorded, and the operation for the demand response continues.

4. The management apparatus according to claim 2, further comprising
a fourth processing unit configured to execute processing to stop the operation for the demand response, in a case where the fourth determination unit determines that there is the inoperable resource among the resources in operation.

5. The management apparatus according to claim 2, further comprising
a fourth processing unit configured to cause all resources in operation to start charging by a predetermined amount, in a case where the fourth determination unit determines that there is the inoperable resource among the resources in operation.

6. The management apparatus according to claim 2, further comprising
a fourth processing unit configured to identify the inoperable resource and start charging only the identified resource by a predetermined amount, in a case where the fourth determination unit determines that there is the inoperable resource among the resources in operation.

7. The management apparatus according to claim 1, wherein
each of the plurality of resources is a vehicle including a battery, and
the information includes:
vehicle state information including a state of charge (SOC) of the battery and a connection state between the vehicle and a power cable; and
schedule information indicating a use schedule of the vehicle.

8. The management apparatus according to claim 7, further comprising
a communication unit capable of performing wireless communication with the vehicle, wherein
at least a part of the information is acquired from the vehicle through the communication unit.

9. The management apparatus according to claim 7, further comprising
a communication unit capable of performing wireless communication with a communication terminal of a user of the vehicle, wherein
at least a part of the information is acquired from the communication terminal through the communication unit.

10. A management method for managing a plurality of resources for responding to a demand response, the management method comprising:
an acquisition step of acquiring information with respect to situations of the plurality of resources;
a first determination step of determining whether it is possible to meet a power condition of the demand response, based on the information, at a first timing after a contract of the demand response and before an operation of the demand response;
a second determination step of determining whether it is possible to meet the power condition of the demand response, based on the information, at a second timing after the first timing and before the operation;
a third determination step of determining whether it is possible to meet the power condition of the demand response, based on the information, while the demand response is in operation,
a first processing step of performing processing of supplementing an external resource different from the plurality of resources, in a case where the first determination step determines that it is impossible to meet the power condition of the demand response;
a second processing step of reallocating a resource scheduled to be operated among the plurality of resources, in a case where the second determination step determines that it is impossible to meet the power condition of the demand response; and
a third processing step of changing a power operation amount of the plurality of resources in operation, in a case where the third determination step determines that it is impossible to meet the power condition of the demand response.
